(19) United States
(12) Patent Application Publication
(10) Pub. No.: US 2011/0063077 A1
(43) Pub. Date: Mar. 17, 2011

(54) VEIN AUTHENTICATION APPARATUS USING TOTAL INTERNAL REFLECTION

(76) Inventors: Il Hyung JUNG, Seoul (KR); Bae Kyun Kim, Gyunggi-do (KR); Kyung No Lee, Seoul (KR); Hae Seung Hyun, Gyunggi-do (KR); Il Kweon Joung, Gyunggi-do (KR)

(21) Appl. No.: 12/610,039

(22) Filed: Oct. 30, 2009

(30) Foreign Application Priority Data
Sep. 16, 2009 (KR) 10-2009-0087689

(51) Int. Cl. G06F 7/04

(52) U.S. Cl. 340/5.83

(57) ABSTRACT

Disclosed herein is a vein authentication apparatus. The vein authentication apparatus includes a protective panel provided with a finger-resting surface, a light entry hole and a light exit hole and configured to totally reflect light, a light source located adjacent to the light entry hole of the protective panel and configured to emit the near infrared rays, an imaging element located adjacent to the light exit hole of the protective panel and configured to acquire a vein pattern, a light entry-side diffraction element located in the light entry hole of the protective panel and configured to guide the light toward the fingertip, a light exit-side diffraction element located in the light exit hole of the protective panel and configured to guide the light toward the imaging element, and an authentication unit configured to perform vein authentication using the vein pattern.

### CROSS REFERENCE TO RELATED APPLICATION

This application claims the benefit of Korean Patent Application No. 10-2009-0087689, filed on Sep. 16, 2009, entitled “Vein Authentication Device using Total Internal Reflection,” which is hereby incorporated by reference in its entirety into this application.

### BACKGROUND OF THE INVENTION

1. Technical Field

The present invention relates to a vein authentication apparatus using total internal reflection in which a protective panel for total internal reflection is provided between a light source and an imaging element, thereby realizing a small size and a slim shape.

2. Description of the Related Art

Recently, with the increased importance of personal information, the need to use biometric authentication technology as a means of protecting information or performing personal identification is rapidly increasing. Such a biometric authentication apparatus is operated as described below.

First, the biometric authentication apparatus is subjected to a user registration process. The user registration process is performed in such a way that the biometric authentication apparatus extracts the biometric features of a person to be registered by reading them and then stores them in a database. Meanwhile, an authentication process is performed in such a way as to authenticate a user by comparing the user's biometric features with the features stored in the database.

Currently, features used by biometric authentication systems include the faces, voices, the shapes of the hands, the irises, the veins, and fingerprints. Research into each type of feature is being actively carried out.

In particular, a biometric authentication system using veins can perform authentication only by presenting part of a human body, such as a user's hand or finger to the system. Accordingly, the vein authentication apparatus using veins meets with low psychological resistance from a user. Furthermore, since the vein authentication apparatus uses the internal information of a living body, it is robust against counterfeiting.

In particular, a finger vein authentication apparatus will now be described. First, the finger vein authentication apparatus radiates infrared light onto a finger. Then, the infrared light scatters inside the finger and then is transmitted to the outside.

Thereafter, the finger vein authentication apparatus captures the infrared light transmitted through the palm side of the finger.

Here, the hemoglobin of the blood absorbs infrared light from the surrounding cells.

Accordingly, an image captured by the finger vein authentication apparatus visualizes blood vessels distributed throughout the hypodermis of the palm side of the finger (finger veins) in the form of a dark shadow pattern (a finger vein pattern).

The finger vein authentication apparatus registers the features of the finger vein pattern in advance.

When authentication is performed, the finger vein authentication apparatus captures an image of the finger presented by a user. Thereafter, the finger vein authentication apparatus performs personal authentication by comparing the finger vein pattern of the captured image with the features which were registered in advance.

FIG. 1 is a diagram showing the construction of a conventional finger vein authentication apparatus 10. The finger vein authentication apparatus 10 includes a light source 1, a camera 2, slits 5 and 6, and a rotating plate 7.

In the above-described finger vein authentication apparatus 10, near infrared light emitted from the light source 1 is deprived of interference light while passing through the slit 5, and is projected onto a finger, which is a target to be measured.

Thereafter, the near infrared light reflected from the finger, which is a target to be measured, is deprived of interference light while passing through the filter 6, and then forms an image on the image sensor of the camera 2, which is an imaging element.

The authentication apparatus 10 uses the rotating plate 7, as shown in the drawing. The rotating plate 7 enables measurement while rotating the target to be measured, thereby enabling three-dimensional (3D) finger vein pattern data to be acquired. The finger vein pattern acquired by the authentication apparatus 10 is subjected to image processing using a program algorithm, and is then used as final vein recognition data.

FIG. 2 is a diagram showing the construction of another conventional finger vein authentication apparatus 20. The vein authentication apparatus 20 includes a light source 23, a transparent acrylic plate 24, an imaging device 25, a transmission filter 26, and a rest 27.

In the authentication apparatus 20, light emitted by the near infrared light source 23 is radiated onto a finger, that is, a target 21 to be measured, and light including vein pattern information is reflected, passes through the transparent acrylic plate 24, and forms an image on the image sensor of the imaging device 25.

Here, in order to acquire vein pattern data, an infrared transmission filter 26 for acquiring an image of near infrared rays while blocking visible rays is disposed in front of the imaging device 25. Here, an optical axis 28 and a capture direction 29 are set to directions perpendicular to the direction of the finger which is placed on the rest 27.

However, the conventional authentication apparatuses are implemented in the form of independent measuring apparatuses and perform vein authentication, so that they have size and cost problems. In particular, the shapes of the conventional apparatuses are limited in application to mobile phone terminals because they do not meet the requirements of a small size and a slim shape.

### SUMMARY OF THE INVENTION

Accordingly, the present invention has been made keeping in mind the above problems occurring in the prior art, and the present invention is directed to a vein authentication apparatus which is capable of providing the path of light emitted by a light source using a protective panel for total internal reflection for totally reflecting the light emitted by the light source, so that a small size and a slim shape can be realized, thereby enabling the authentication apparatus to be installed in a mobile phone terminal.

In order to accomplish the above object, the present invention provides a vein authentication apparatus, including a protective panel made of a plate-shaped transparent material, provided with a finger-resting surface on which a fingertip is placed, provided with a light entry hole which is formed on one side of a surface opposite the finger-resting surface with respect to a reference line and which is configured to receive near infrared rays and totally reflect the near infrared rays toward the fingertip placed on the finger-resting surface, and provided with a light exit hole which is formed on the other side of the surface opposite the finger-resting surface with respect to the reference line, which is opposite the side on which the light entry hole is disposed, and which is configured to emit light reflected from the fingertip; a light source located adjacent to the light entry hole of the protective panel, and configured to emit the near infrared rays; an imaging element located adjacent to the light exit hole of the protective panel, and configured to receive the light reflected from the fingertip and then acquire a vein pattern; a light entry-side diffraction element located in the light entry hole of the protective panel, and configured to guide the light emitted by the light source toward the fingertip; a light exit-side diffraction element located in the light exit hole of the protective panel, and configured to guide the light reflected from the fingertip toward the imaging element; and an authentication unit configured to perform vein authentication using the vein pattern acquired by the imaging element.

The protective panel is located on a surface of an LCD panel of a portable terminal, the light source is located on one side of the LCD panel, and the imaging element is located on a remaining side of the LCD panel opposite that on which the light source is located.

A finger-resting surface partitioned off from the protective panel is located within the LCD panel.

The light entry-side diffraction element and the light exit-side diffraction element are formed of diffraction gratings.

The vein authentication apparatus further includes a visual light blocking filter for blocking visible rays, the visual light blocking filter being disposed between the protective panel and the imaging element.

The vein authentication apparatus further includes a condenser lens for condensing the reflected light onto the imaging element, the condenser lens being disposed between the protective panel and the imaging element.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of a conventional finger vein authentication apparatus;

FIG. 2 is a diagram showing the construction of another conventional finger vein authentication apparatus;

FIG. 3 is a diagram showing the construction of a vein authentication apparatus using total internal reflection according to an embodiment of the present invention;

FIG. 4 is a sectional view showing an application in which the vein authentication apparatus using total internal reflection according to the embodiment of the present invention has been applied to a mobile phone terminal;

FIG. 5A is a plan view showing a vein authentication apparatus according to an embodiment of the present invention, which has been applied to a mobile phone terminal; and

FIG. 5B is a diagram showing the vein authentication apparatus with a fingertip placed on a finger-resting surface.

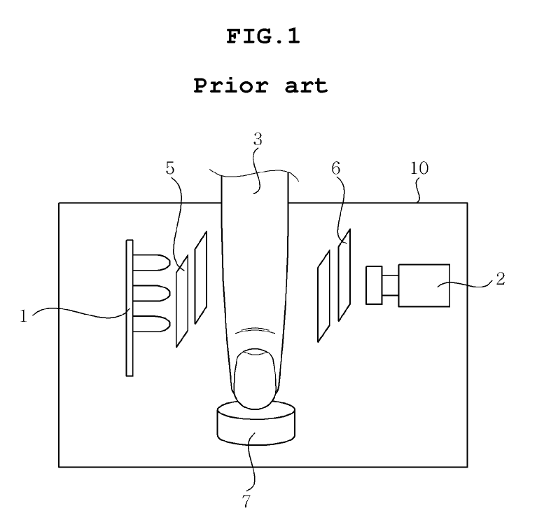

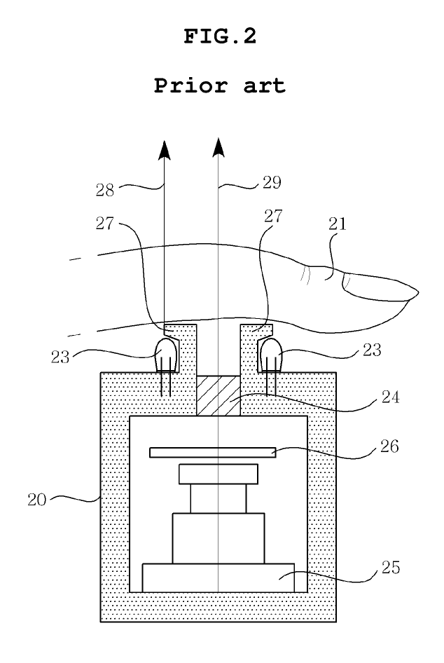

### DESCRIPTION OF THE PREFERRED EMBODIMENTS

A vein authentication apparatus according to an embodiment of the present invention will be described in detail with reference to the accompanying drawings. In the description, the same reference numerals are used throughout the different drawings to designate the same or corresponding components, and related redundant descriptions will be omitted.

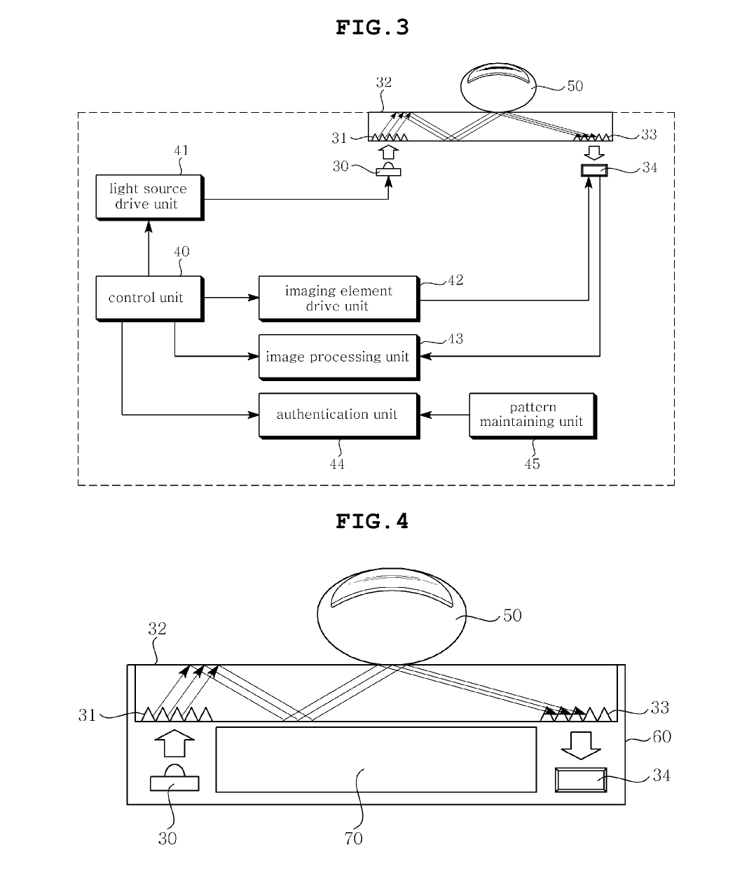

FIG. 3 is a diagram showing the construction of a vein authentication apparatus using total internal reflection according to an embodiment of the present invention.

As shown in FIG. 3, the vein authentication apparatus using total internal reflection according to the embodiment of the present invention includes a light source 30, a light entry-side diffraction element 31, a protective panel for total internal reflection 32, a light exit-side diffraction element 33, an imaging element 34, a control unit 40, a light source drive unit 41, an imaging element drive unit 42, an image processing unit 43, an authentication unit 44, and a pattern maintaining unit 45.

The light source 30 radiates light to a fingertip 50, and is formed of, for example, a Light Emitting Diode (LED).

The light source 30 is disposed opposite the imaging element 34 with respect to the fingertip 50, and is disposed at a location opposite that of the imaging element 34 in the transverse direction (the x direction) of the fingertip 50. The light source 30 radiates light in a wavelength range of 700 to 1200 nm so as to capture a user's veins, which are internal organs of the fingertip 50.

Meanwhile, the light entry-side diffraction element 31 is disposed in a light entry hole adjacent to the light source 30 of the protective panel 32, that is, is disposed adjacent to the light source 30, and guides light, emitted from the light source 30, toward the fingertip 50 placed on the protective panel 32.

The light exit-side diffraction element 33 is disposed in a light exit hole adjacent to the imaging element 34 of the protective panel 32, that is, is disposed adjacent to the imaging element 34, and guides light, reflected from the fingertip 50 and moved away from the fingertip 50, toward the imaging element 34.

The light exit-side diffraction element 33 is disposed opposite the light entry-side diffraction element 31 with respect to the fingertip 50, and is disposed opposite the light entry-side diffraction element 31 in the transverse direction (x direction) of the fingertip 50.

Diffraction gratings may be used as the diffraction elements 31 and 33. The specifications of the diffraction gratings are determined depending on the wavelength of the near infrared light source 30 used for the measurement of a vein pattern and the thickness and refractive index of the protective panel 32.

For example, when the wavelength of the light source 30 falls within the near infrared region of 700-4200 nm, the thickness of the protective panel 32 is 1 mm and the refractive index of the protective panel 32 is 1.5, it is preferred that the diffraction gratings have a grating period in the range of 500-900 nm. Such a diffraction grating with such a period can be manufactured by forming a master using a semiconductor process using lithography or a photo mask, performing stamper work and finally conducting a molding process.

The protective panel 32 is made of a plate-shaped transparent material, and has a finger-resting surface on which the fingertip 50 is placed. The finger-resting surface may be located at the center of the protective panel 32, or may be located on one side of the protective panel 32. In particular, it is preferred that the finger-resting surface be located above the center of the protective panel 32.

As described above, the protective panel 32 provides a region (surface) on which the fingertip 50 is placed. However, it is not necessary to directly bring the fingertip 50 into contact with the protective panel 32 and the fingertip 50 may be merely placed above the protective panel 32.

The protective panel 32 is made of a plate-shaped transparent material as described above, thereby preventing impurities, such as dust, from entering into the apparatus.

Furthermore, the protective panel 32 is provided with the light entry hole on one side of a surface opposite the finger-resting surface, and the light entry hole receives near infrared rays and totally reflects the near infrared rays toward the fingertip 50 placed on the finger-resting surface. Furthermore, the protective panel 32 is provided with the light exit hole on the other side of the surface opposite the finger-resting surface, which is opposite the side on which the light entry hole, and emits light reflected from the fingertip 50.

The protective panel 32 constructed as described above totally reflects incident light so as to direct the incident light toward the fingertip 50 placed on the protective panel 32 and direct light reflected from the fingertip 50 toward the light exit-side diffraction element 33.

Here, total internal reflection refers to a phenomenon in which light with an incident angle equal to or grater than a specific angle is entirely reflected from the boundary surface of a medium, and is used for optical communication using optical fiber. The protective panel 32 is made of transparent material such as glass or resin.

An element for transmitting only near infrared light may be used as the protective panel 32. If so, unnecessary light, such as solar light or fluorescent lamp light, can be prevented when a vein pattern is captured.

Meanwhile, the imaging element 34 is disposed adjacent to the light exit hole of the protective panel 32, captures light reflected from the inside of the fingertip 50 and emitted from the desired protective panel 32, and is formed of, for example, a CCD or a CMOS sensor.

In order to extract and use only a vein pattern using near infrared light, a visual light blocking filter (not shown) may be used as the imaging element 34.

The visual light blocking filter may be disposed between the light exit-side diffraction element 33 and the imaging element 34, and limits the entry of incident light into the imaging element 34 by selectively blocking the light emitted by the light exit-side diffraction element 33.

A condenser lens (not shown) may be disposed between the imaging element 34 and the protective panel 32 so as to condense light radiated onto the fingertip 50 by forming an image of the desired target surface of the fingertip 50 on the light receiving surface of the imaging element 34. However, the thickness or diameter of the condenser lens may be appropriately set by taking into account the desired magnification of a formed image or resolution.

Meanwhile, the image processing unit 43, under the control of the control unit 40, performs predetermined image processing on captured data obtained by the imaging element 34 and outputs the captured data to the authentication unit 44. The image processing unit 43, and the authentication unit 44 and the control unit 40, which will be described later, are formed of, for example, a microcomputer.

The pattern maintaining unit 45 maintains a vein authentication pattern (which is a comparative pattern to be compared with a captured pattern acquired when authentication is performed and is acquired by previously capturing finger veins), and is formed of to nonvolatile memory (for example, Electrically Erasable Programmable Read Only Memory (EEPROM)).

The authentication unit 44, under the control of the control unit 40, authenticates the fingertip 50 by comparing a vein pattern output by the image processing unit 43 with the vein authentication pattern maintained by the pattern maintaining unit 45.

The light source drive unit 41 operates the light source 30 in response to the control of the control unit 40. The imaging element drive unit 42 performs image capturing driving (light receiving driving) on the imaging element 34 in response to the control of the control unit 40. The control unit 40 controls the operation of the image processing unit 43, the authentication unit 44, the light source drive unit 41 and the imaging element drive unit 42.

Next, the operation and advantages of the vein authentication apparatus using total internal reflection according to the embodiment of the present invention will be described below.

In the vein authentication apparatus, when the fingertip 50 is placed on the protective panel 32, the light source 30 is operated by the light source drive unit 41, and near infrared rays are emitted by the light source 30.

Meanwhile, the path of the light emitted by the light source 30 is changed by the light entry-side diffraction element 31 such that it can be directed toward the fingertip 50.

When the path of the light emitted by the light source 30 is changed by the light entry-side diffraction element 31, the light is incident on the upper surface of the protective panel 32 on which the fingertip 50 is placed, in which case the protective panel 32 performs total reflection such that the incident light is directed toward the lower surface of the protective panel 32 opposite the upper surface of the protective panel 32 on which the fingertip 50 is placed.

Thereafter, the light incident on the lower surface of the protective panel 32 opposite the upper surface on which the fingertip 50 is placed is totally reflected by the upper surface opposite the lower surface on which the fingertip 50 is placed, so that the incident light can be directed toward the fingertip 50.

Thereafter, the light incident on the fingertip 50 is reflected by the fingertip 50, and is then scattered in all directions.

Thereafter, the light which meets the total reflection requirement of the protective panel 32 is finally directed toward the light exit-side diffraction element 33 located in the light exit hole of the protective panel 32.

Thereafter, the light exit-side diffraction element 33 passes the light reflected from the fingertip 50 placed on the protective panel 32 toward the imaging element 34 so that the reflected light is focused on the light receiving surface of the imaging element 34. By doing so, the captured data of the veins of the fingertip 50 is acquired by the imaging element 34.

Thereafter, the vein pattern acquired by the imaging element 34 is subjected to appropriate image processing by the image processing unit 43, and is input to the authentication unit 44. The authentication unit 44 performs authentication by comparing the input vein pattern with the authentication pattern used for vein authentication and maintained by the pattern maintaining unit 45. As a result, a vein authentication result (authentication result data Dout) is output, thus completing vein authentication.

Meanwhile, since the vein authentication apparatus using total internal reflection according to the embodiment of the present invention can be implemented in a small size and a slim shape, it can be applied to a portable terminal.

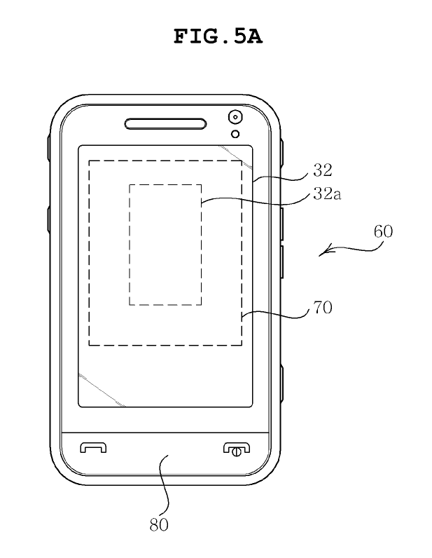

FIG. 4 is a sectional view showing an application in which the vein authentication apparatus using total internal reflection according to the embodiment of the present invention has been applied to a mobile phone terminal 70.

As shown in FIG. 4, the vein authentication apparatus according to the embodiment of the present invention is installed on the mobile phone terminal 70.

A light source 30 is located on one side of an LCD panel 70, and is located opposite the imaging element 34 with respect to a fingertip 50, that is, opposite an imaging element 34 in the transverse direction (the x direction) of the fingertip 50.

Next, a protective panel 32 is located to cover the upper surface of the LCD panel 70, and protects the LCD panel 70 from the outside. A light entry-side diffraction element 32 is disposed in a light entry hole adjacent to the light source 30, while a light exit-side diffraction element 33 is disposed in a light exit hole adjacent to the imaging element 34.

Meanwhile, the imaging element 34 is located on the outer side of the LCD panel 70, and is located on the side opposite that on which the light source 30 is located with respect to the fingertip 50.

As described above, the light source 30 and the imaging element 34 are located on respective sides of the LCD panel 70, and the protective panel 32 is placed above the LCD panel 70, so that the vein authentication apparatus according to the embodiment of the present invention enables the application of the present invention to be applied to a mobile phone terminal without increasing the size of the mobile phone terminal.

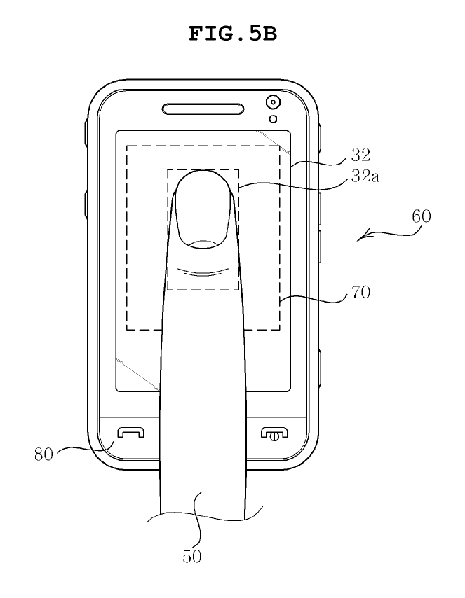

FIG. 5A is a plan view showing a vein authentication apparatus according to an embodiment of the present invention, which has been applied to a mobile phone terminal 60. The surface of the vein authentication apparatus is formed of the surface of a protective panel 32 covering an LCD panel 70 in the mobile phone terminal 60 including the LCD panel 70 and a keypad 80.

A part of the surface of the vein authentication apparatus is partitioned off, and forms a finger-resting surface 32a capable of recognizing a vein pattern when a finger of a measurement target is placed thereon.

In order to increase the accuracy of the recognition of the veins of the finger, the finger-resting surface 32a formed by partitioning off a part of the surface of the vein to authentication apparatus may be formed to be smaller than the surface of the LCD panel 70, as shown in FIG. 5A.

It will be apparent that the size of the finger-resting surface 32a may be implemented to be larger than that of the LCD panel 70.

Here, since the finger-resting surface 32a has a flat structure as a whole, the authentication apparatus is able to be installed on apparatuses which do not allow depressed and protruding shapes due to physical and design limitations, such as a notebook Personal Computer (PC), a Personal Digital Assistant (PDA), the surface of a keyboard, and the surface of the manipulation panel of an Automatic Teller Machine (ATM), in addition to a mobile phone terminal.

FIG. 5B is a diagram showing the vein authentication apparatus with the fingertip 50 placed on the finger-resting surface 32a.

According to the above-described present invention, it is possible to implement a small and slim vein authentication apparatus so that it can be applied to a mobile phone terminal.

Furthermore, according to the present invention, it is possible to impart a user authentication function using biometric information to a mobile phone terminal, so that an advantage arises in that the security of a mobile phone terminal can be significantly increased.

Moreover, according to the present invention, user authentication can be made only by bringing a user's finger to the LCD screen of a mobile phone terminal, so that another advantage arises in that the user's convenience can be significantly increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A vein authentication apparatus, comprising:
a protective panel made of a plate-shaped transparent material, provided with a finger-resting surface on which a fingertip is placed, provided with a light entry hole which is formed on one side of a surface opposite the finger-resting surface with respect to a reference line and which is configured to receive near infrared rays and totally reflect the near infrared rays toward the fingertip placed on the finger-resting surface, and provided with a light exit hole which is formed on a remaining side of the surface opposite the finger-resting surface with respect to the reference line, which is opposite the side on which the light entry hole is disposed, and which is configured to emit light reflected from the fingertip;
a light source located adjacent to the light entry hole of the protective panel, and configured to emit the near infrared rays;
an imaging element located adjacent to the light exit hole of the protective panel, and configured to receive the light reflected from the fingertip and then acquire a vein pattern;
a light entry-side diffraction element located in the light entry hole of the protective panel, and configured to guide the light emitted by the light source toward the fingertip;
a light exit-side diffraction element located in the light exit hole of the protective panel, and configured to guide the light reflected from the fingertip toward the imaging element; and
an authentication unit configured to perform vein authentication using the vein pattern acquired by the imaging element.

2. The vein authentication apparatus as set forth in claim 1, wherein the protective panel is located on a surface of a Liquid Crystal Display (LCD) panel of a portable terminal, the light source is located on one side of the LCD panel, and the imaging element is located on a remaining side of the LCD panel opposite that on which the light source is located.

3. The vein authentication apparatus as set forth in claim 2, wherein a finger-resting surface partitioned off from the protective panel is located within the LCD panel.

4. The vein authentication apparatus as set forth in claim 1, wherein the light entry-side diffraction element and the light exit-side diffraction element are formed of diffraction gratings.

5. The vein authentication apparatus as set forth in claim 1, further comprising a visual light blocking filter for blocking visible rays, the visual light blocking filter being disposed between the protective panel and the imaging element.

6. The vein authentication apparatus as set forth in claim 1, further comprising a condenser lens for condensing the reflected light onto the imaging element, the condenser lens being disposed between the protective panel and the imaging element.
